(19) United States
(12) Patent Application Publication
(10) Pub. No.: US 2008/0012328 A1
(43) Pub. Date: Jan. 17, 2008

(54) SANITARY LINE CONNECTION

(75) Inventors: Alexander Stein, Ihringen (DE); Joachim Kunze, Mullheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: NEOPERL GMBH, Mullheim (DE)

(21) Appl. No.: 11/534,363

(22) Filed: Sep. 22, 2006

(30) Foreign Application Priority Data
Sep. 29, 2005 (DE) 102005046674.5

(51) Int. Cl. F16L 17/00

(52) U.S. Cl. 285/355

(57) ABSTRACT

A sanitary line connection is provided, which has a sleeve shape at least in a front-end region thereof and in which there is at least one sealing ring (7) clamped in a sealing way between the adjacent line section and the line connection. The line connection can be embodied, for example, as a sanitary outlet nozzle (1), with at least one retaining cam or similar retaining projection (9) projecting from the outer periphery of the sealing ring (7). The retaining projection (9) engages in an indentation or similar recess in the sleeve interior of the sleeve-shaped front-end region.

### BACKGROUND

The invention relates to a sanitary line connection, which is sleeve-shaped at least in its one front-end region and in which at least one sealing ring is provided, which is clamped in a sealed way between the adjacent line section and the line connection.

From DE 30 00 799 A1 (see FIG. 1), a jet regulator is already known, which can be inserted into an outlet nozzle that can be mounted on the fixture or armature outlet of a sanitary fixture. The previously known outlet fitting is formed as an insert cartridge, which can be pushed from the feed side into the sleeve interior of the outlet nozzle. The outlet nozzle has an internal thread, which interacts with an external thread on the fixture outlet. In the sleeve interior of the outlet nozzle, a sealing ring is provided, which exerts an axial-sealing force on the feed-side front edge of the insert cartridge and thus can be clamped between the outlet nozzle on one side and the adjacent front edge of the outlet fitting on the other side.

The jet regulator and the associated outlet nozzle are usually provided together in a common package. However, when handling and transporting these relatively large packages, there is the risk that the sealing ring, the jet regulator, and the outlet nozzle can separate from each other and also that the jet regulator formed as an insert cartridge can fall apart into its component pieces. This and the condition that the components, which are set one in the other, require a defined relative position to each other on one hand and to the outlet fitting on the other hand can make the assembly of a corresponding sanitary water outlet significantly more difficult.

### SUMMARY

Therefore, the objective is to create a sanitary line connection, whose handling, especially during assembly, is simplified significantly.

The solution to this objective according to the invention is that, in the sanitary line connection of the above-noted type, in particular, at least one retaining cam or similar retaining projection projects on the outer periphery of the sealing ring, with this retaining projection engaging in an indentation or similar recess in the sleeve interior of the sleeve-shaped front-end region.

The one or more sealing rings of the line connection according to the invention have at least one retaining cam or similar retaining projection. The one or more retaining cams or similar retaining projections project from the outer periphery of the one or more sealing ring, such that the retaining cams or similar retaining projections engage in indentations or similar recesses provided on the sleeve-shaped front-end region of the line connection and can be clamped there. In this way, the sealing ring and with it the components also provided in the sleeve interior of the line connection are secured such that these components do not disengage unintentionally, for example, due to vibrations caused during transport—but nevertheless can be easily separated from each other when necessary. Therefore, the line connection according to the invention distinguishes itself through simple handling, especially in assembly.

The indentation or similar recess provided on the sleeve-shaped front-end region of the line connection can be formed, for example, as an annular groove, which extends around the inner periphery of the sleeve-shaped front-end region and in which the one or more retaining projections on the sealing ring can engage. However, a preferred embodiment according to the invention provides that the line connection carries an internal thread in the sleeve interior of its sleeve-shaped front-end region for connection to a sanitary fixture or similar feed-side line section and that the indentation or similar recess is formed by the internal thread, with the one or more retaining cams or similar retaining projections engaging in this internal thread.

The line connection according to the invention can be embodied, for example, as a connection nut, which connects two pipe sections of a water line to each other. However, a preferred embodiment according to the invention provides that the line connection is embodied as an outlet nozzle, which can be mounted with its internal thread on the discharge-side external thread of a sanitary outlet fixture.

The line connection according to the invention can be used particularly advantageously when at least one insert cartridge or a similar sanitary insert part can be inserted into the sleeve interior of the sanitary line connection and when the one or more sealing rings secure the one or more insert parts in the sleeve interior. In this embodiment, the one or more sanitary insert parts, which should sit as loosely as possible in the outlet nozzle, are held in their position so that they cannot be lost by the clamped seal on the inner periphery of the line connection for assembly purposes and especially for transport purposes. On the other hand, the positional fixing is also only strong enough so that the one or more insert parts can be pressed out of the outlet nozzle by end customers without too great an expenditure of force, which is very important especially for jet regulator inner parts with inserted screens. Here, if force is applied from the bottom side onto the contact surface, the screen can be deformed and the functionality of the jet regulator can be destroyed. Through the locking cams or locking projections on the outer periphery of the sealing ring and through their geometric shape, the retaining force can be defined relatively easily. Indeed, it would also be possible to over-dimension the complete sealing ring and to press it fixed into the internal thread during the assembly process, but the retaining force for the insert parts located in the line connection is large enough that these can also be disassembled by slightly pressing on the insert parts from the outlet side when the end consumer changes these parts, in order, for example, to clean or replace these insert parts. Through the sealing ring embodied according to the invention, the package of the components can be simplified significantly, which normally should ensure that the jet regulator and its insert parts, as well as the loosely inserted seals cannot fall out of the nozzle even over long transport distances. For the fixture manufacturer, the use of the line connection according to the invention with its specially embodied sealing ring also has the advantage that the assembly of complete jet regulators on the outlet fitting can also be performed with the thread downwards or on the outlet opening upwards. This assembly method is widely used, because it is more favorable based on ergonomics. However, a prerequisite is always that the seal required on the feed side does not fall downwards when the jet regulator is turned.

So that the sealing ring can simultaneously ensure an axial seal also in the region of the line connection, it is preferable that the sealing ring applies a sealing force on the feed-side front edge of an insert part inserted into the sleeve interior of the sanitary line connection.

To be able to secure the sealing ring with sufficient clamping effect in the sleeve interior of the line connection embodied, for example, as a fixture outlet nozzle, it is advantageous when at least two retaining projections are distributed over the outer periphery of the sealing ring. So that the sealing ring can be clamped tight especially well in the indentation embodied preferably as an internal thread on the inner periphery of the line connection, it is advantageous when at least one retaining projection has at least on one side in the longitudinal direction of the line connection, preferably on both sides, rounded or beveled free outer edges.

A preferred embodiment according to the invention provides that the one or more insert parts has a jet regulator or is embodied as a jet regulator.

Improvements according to the invention are given in other subordinate claims and in the description.

### BRIEF DESCRIPTION OF THE DRAWINGS

Below, the invention is explained and described in even more detail with reference to a preferred embodiment.

Shown are:

FIG. 1 is a partial longitudinal section view of a jet regulator located in an outlet nozzle, with the jet regulator being secured with the help of a sealing ring in the outlet nozzle, which engages in an internal thread on the outlet nozzle via retaining cams projecting on the side of the outer periphery,

FIG. 2 is a detailed view of the jet regulator from FIG. 1 in a region of its sealing ring,

FIG. 3 is a perspective view of the sealing ring of the jet regulator from FIGS. 1 and 2,

FIG. 4 is a top view of the sealing ring from FIG. 3, and

FIG. 5 is a side view of the sealing ring from FIG. 4.

### DETAILED DESCRIPTION OF THE PREFERRED EMBODIMENTS

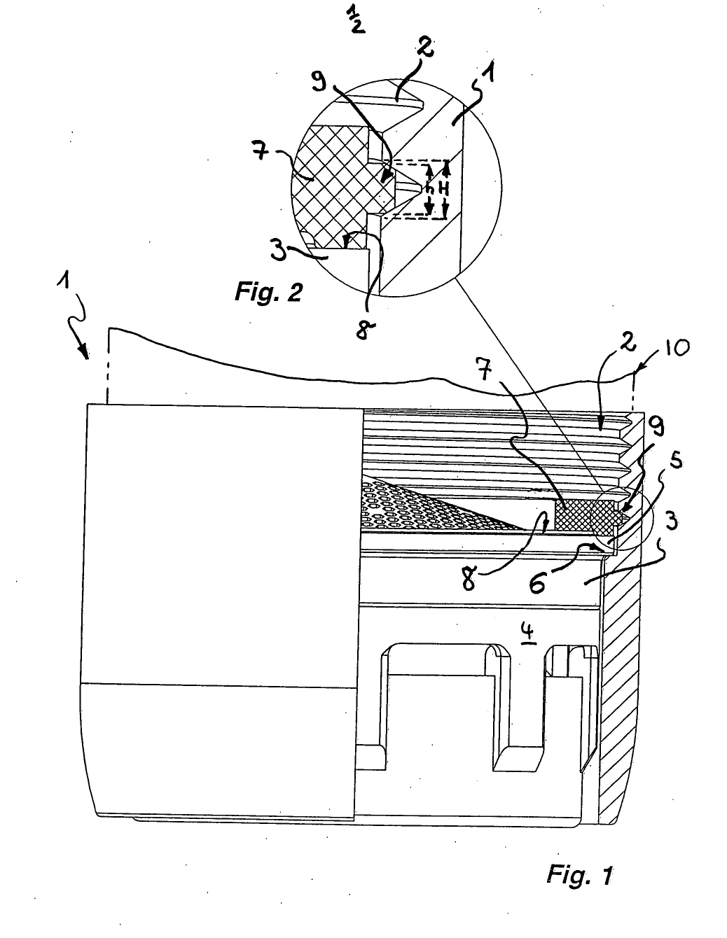

In FIG. 1, a sanitary line connection is shown, which is embodied here as an outlet nozzle 1. The outlet nozzle 1 also has a sleeve shape in its feed-side front-end region and has an internal thread 2 in the sleeve interior of this front-end region. This internal thread can be mounted detachably on the external thread of a sanity outlet fitting not shown here in more detail.

From FIG. 1 it becomes clear that a sanitary insert part, which is formed here as an aerated jet regulator 3, can be inserted into the outlet nozzle 1. The jet regulator 3 has an annular flange 5, which, in the position of use, contacts an annular shoulder 6 in the sleeve interior of the outlet nozzle 1, on its jet regulator housing 4.

To be able to seal the separating plane between the jet regulator 3 and the line section connected upstream on the feed side in the axial direction, a sealing ring 7 is provided, which is also inserted into the sleeve interior of the outlet nozzle 1. This sealing ring 7 applies a sealing force on the feed-side front edge 8 of the jet regulator 3 and is clamped between the outlet nozzle 1 and the adjacent water outlet of the outlet fitting connected upstream.

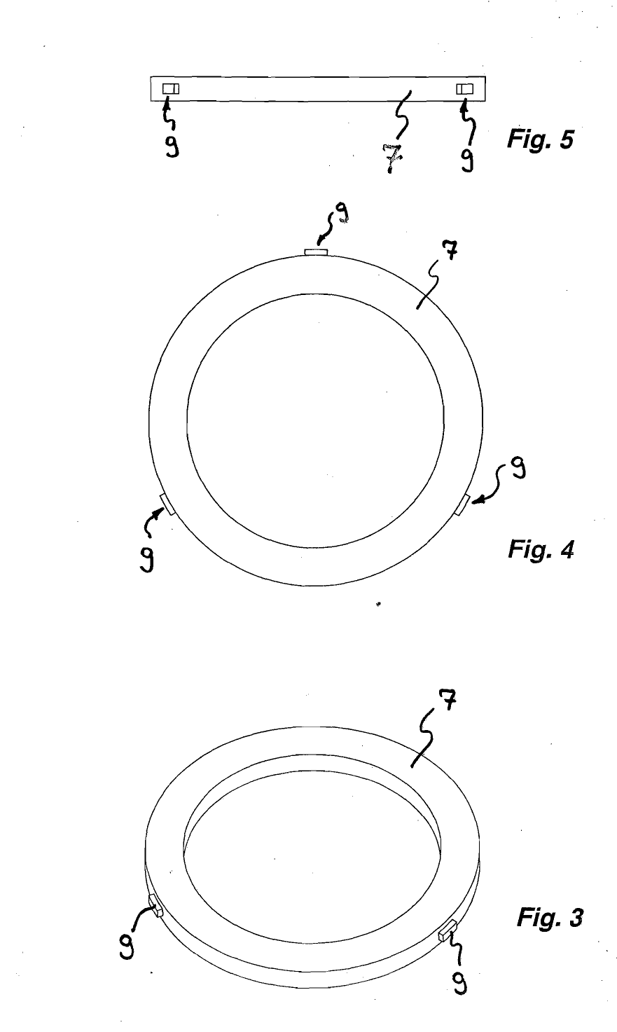

From a comparison of FIGS. 1 to 5, it becomes clear that the sealing ring 7 has three retaining projections or cams 9, which project on the outer periphery of the sealing ring 7 and are generally uniformly distributed over the periphery. In FIG. 2 it can be seen that the retaining projections 9 have a height h, which is smaller than the open height H of a thread pitch of the internal thread 2. Thus, the retaining projections 9 can engage securely and rigidly in the internal thread 2 in the sleeve interior of the outlet nozzle 1, such that the sealing ring 7 and with it also the outlet side jet regulator 3 are held so that they cannot be lost. In FIG. 2 it is indicated that the sealing ring has retaining projections, which have rounded or beveled free outer edges on both sides in the longitudinal direction of the line connection.

The retaining projections 9 formed in one piece on the outer periphery of the sealing ring engage in the internal thread 2 in the sleeve interior of the sleeve-shaped front-end region of the outlet nozzle 1, such that the sealing ring 7 and with it the components also provided in the sleeve interior of the outlet nozzle are secured so that these components cannot become detached unintentionally, for example, due to vibrations caused by transportation.

1. Sanitary line connection having a seal, comprising a sleeve shaped front-end region in which at least one sealing ring (7) is adapted to be clamped in a sealing manner between an adjacent line section and the line connection, at least one retaining cam or retaining projection (9) projects beyond an outer circumference defining a periphery of the sealing ring (7), with the retaining cam or projection (9) engaging in an indentation or recess in an interior of the sleeve-shaped front-end region.

2. Line connection according to claim 1, wherein the line connection includes an internal thread (2) in the interior of the sleeve-shaped front-end region for connecting to a sanitary fitting or feed-side line section and the indentation or recess is formed by the internal thread (2), with the at least one retaining cam or projection (9) engaging in the internal thread.

3. Line connection according to claim 1, further comprising at least one insert cartridge or sanitary insert part inserted into the interior of the sleeve shaped front-end region of the sanitary line connection and the at least one sealing ring (7) secures the at least one insert cartridge or part in the sleeve interior.

4. Line connection according to claim 3, wherein the sealing ring (7) applies a sealing force on a feed-side front edge of the insert part (3) inserted into the sleeve interior of the sanitary line connection.

5. Line connection according to claim 1, wherein the at least one retaining cam or projection comprises at least two retaining projections or cams (9) distributed over an outer periphery of the sealing ring (7).

6. Line connection according to claim 5, wherein the retaining projections (9) are distributed uniformly on the outer periphery.

7. Line connection according to claim 2, wherein the at least one retaining projection (9) has a height h, which is smaller than an open height H of a thread pitch of the internal thread (2).

8. Line connection according to claim 1, wherein the at least one retaining projection (9) has rounded or beveled free outer edges at least on one side in a longitudinal direction.

9. Line connection according to claim 8, wherein the at least one retaining projection (9) has rounded or beveled free outer edges on both sides in a longitudinal direction.

10. Line connection according to claim 1, further comprising one or more insert parts inserted into the interior of the sleeve shaped front-end region of the sanitary line connection and the at least one sealing ring (7) secures the at least one insert cartridge or part in the sleeve interior, and the one or more insert parts comprise a jet regulator or jet regulators (3).
